(19) United States
(12) Patent Application Publication
(10) Pub. No.: US 2009/0163179 A1
(43) Pub. Date: Jun. 25, 2009

(54) System, Apparatus and Method for Transporting Mobile Device Text Messages to a Cordless Telephone System

(75) Inventors: Michael H. Brannan, Alpharetta, GA (US); Barry James Folsom, Los Altos Hills, CA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/960,165

(22) Filed: Dec. 19, 2007

(51) Int. Cl. H04M 3/533

(52) U.S. Cl. 455/412.2; 455/412.1

(57) ABSTRACT

Systems (10, 40), devices (12, 42) and methods for transporting mobile device message data, such as text messages, between a mobile device and a cordless telephone device. The systems include a cordless telephone base station having incorporated therein the ability to transport text messages from a connected or associated mobile device. The base station includes a message decoder that determines which portions of data received by the base station are message data. The message data can be displayed on the base station's cordless handset. Alternatively, the systems include a mobile device docking system that bridges the ability to receive text messages from a mobile device, such as a cellular telephone or other handheld mobile device, to a cordless telephone base station. The mobile device docking system is connected between the mobile device and the cordless telephone base station, e.g., via a wired connection or wirelessly, e.g., via a Bluetooth connection.

### BACKGROUND OF THE INVENTION

1. Field of the Invention

The invention relates to cordless telephones, including cordless telephone base stations and handsets. More particularly, the invention relates to cordless telephones having the ability to receive text messages from an associated mobile device, such as a cellular telephone or other handheld mobile device.

2. Description of the Related Art

Short Message Service (SMS) is a wireless service available to most cellular telephones and other mobile devices that allows for sending and receiving of short alphanumeric messages, also know as text messages, between the mobile devices. Many cellular telephones and other mobile devices, such as personal digital assistants (PDAs), smartphones and other wireless handheld devices, have the ability to transmit and receive SMS messages.

SMS originally was designed as part of the Global System for Mobile communications (GSM) digital mobile phone standard, but now is available on a wide range of networks, including third generation (3G) networks. Messaging is handled by a Short Message Service Center (SMSC), which typically is part of the operator or service provider network.

Currently, when an SMS message arrives on a user's cell phone or other mobile device when the user is at home, the user may not be aware that the SMS message arrived if the user's mobile device is not with the user. Conventional devices exist for docking or bridging cellular phones to landline devices, e.g., to corded telephones or cordless telephones, including cordless base stations and their corresponding handsets. However, such devices typically only bridge audio (i.e., voice), caller identification (caller ID) information and SMS message alerts from the cellular telephone to the landline telephone. Also, conventional methods exist for forwarding text messages intended for a first mobile device to a second mobile device or computer using a mobile switching center (MSC), which is a switching exchange within the service provider network. However, such method does not involve mobile device docking or bridging devices.

### BRIEF DESCRIPTION OF THE DRAWINGS

FIG. 1 is a block diagram of a system including a cordless telephone device having incorporated therein the ability to transport wireless text message data between an associated mobile device and the cordless telephone device handset; and

FIG. 2 is a block diagram of a system including a mobile device docking station for transporting wireless text message data between a mobile device and a cordless telephone device.

### DETAILED DESCRIPTION

In the following description, like reference numerals indicate like components to enhance the understanding of the text message transporting systems, devices and methods through the description of the drawings. Also, although specific features, configurations and arrangements are discussed hereinbelow, it should be understood that such specificity is for illustrative purposes only. A person skilled in the relevant art will recognize that other steps, configurations and arrangements are useful without departing from the spirit and scope of the invention.

The devices and systems described herein involve the ability of mobile devices, such as cellular telephones and other handheld mobile devices, to receive text messages to a cordless telephone base station by transporting text messages from the mobile device to the cordless telephone, including the cordless telephone handset. In this manner, the notification of an incoming text message and the body of the message is received by the cordless handset. Transporting text messages from the mobile device to the cordless telephone is achieved by a mobile device docking system configured to transport text messages received by the mobile device to a cordless telephone base station and its cordless handset. Alternatively, the cordless telephone base station itself is configured to transport text messages from a connected or associated mobile device to the base station's cordless handset. The cordless telephone, via its handset, also can be configured to transmit text messages to the mobile device, e.g., in response to the receipt of text messages transported from the mobile device.

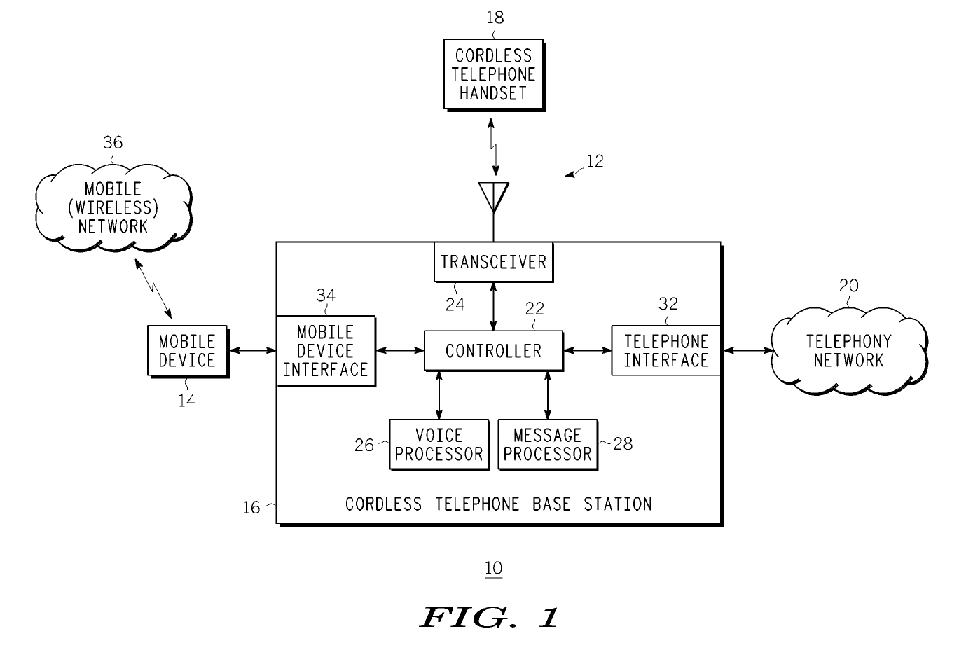

Referring now to FIG. 1, shown is a block diagram of a system 10 including a cordless telephony or telephone device 12 having incorporated therein the ability to transport wireless text message data from an associated mobile device 14. The cordless telephone device 12 includes a cordless telephone base station 16 and one or more cordless, portable telephone handsets 18. The cordless base station 16 is connected to a telephony network 20, such as a telephone company phone system, via a landline telephone connection or other suitable connection.

The cordless telephone base station 16 includes a controller 22 and a cordless transceiver or radio transceiver 24 coupled to the controller 22. The cordless transceiver 24 is configured to communicate wirelessly with the cordless handset 18, which also includes a cordless or radio transceiver (not shown). In general, conventionally, the transceiver 24 transmits and receives voice data traffic, in the form of radio frequency (RF) signals, to and from the handset 18. The controller 22 typically includes the hardware and/or software necessary to control the operation of the cordless telephone device 12, including the administration of wireless communications between the base station 16 and the handset 18, and between the base station 16 and the telephony network 20. The cordless base station 16 has an assigned landline telephone number that allows a user to place and receive calls using the cordless portable handset 18 within a limited range of the cordless base station 16, such as within a home.

The cordless telephone base station 16 also includes a voice processor 26 coupled to the controller 22, a message processor 28 coupled to the coupled to the controller 22, and one or more interfaces, e.g., a telephone interface 32 for coupling the cordless telephone base station 16 to the telephony network 20. The cordless telephone base station 16 also includes a mobile device interface 34 for coupling the mobile device 14 to the cordless telephone base station 16, as will be discussed in greater detail hereinbelow. It should be understood that the interfaces 32, 34 can be a single interface or part of a single interface configured to couple the base station 16 to one or both of the telephony network 20 and the mobile device 14.

The handset 18 and one or more of the controller 22, the transceiver 24, the voice processor 26, the message processor 28 and the interfaces can be comprised partially or completely of any suitable structure or arrangement, e.g., one or more integrated circuits. Also, it should be understood that the cordless telephone device 12 includes other components, hardware and software (not shown) that are used for the operation of other features and functions of the cordless telephone device 12 not specifically described herein.

The cordless telephone device 12 can be any suitable device that supports any suitable landline telephony operation. For example, the cordless telephone device 12 can be a telephone that is part of a plain old telephone service (POTS) analog telephone service, a digital telephone service, and/or a Voice over Internet Protocol (VoIP) telephone service. Alternatively, the cordless telephone device 12 can be part of or connected to a residential gateway, a home media server, a home area network (HAN) server, a signal converter box, a signal decoder box, a digital set-top box, a digital video disk recorder, a personal video recorder (PVR) device, a networking device, such as an 802.11x networking device, a wireless router, a desktop personal computer (PC), a laptop PC, a notebook PC, a television, an audio receiver and a video receiver.

The cordless telephone device 12 can be partially configured in the form of hardware circuitry and/or other hardware components within a larger device or group of components. Alternatively, the cordless telephone device 12 can be partially or completely configured in the form of software, e.g., as processing instructions and/or one or more sets of logic or computer code. In such configuration, the logic or processing instructions typically are stored in a data storage device (not shown). The data storage device typically is coupled to a processor or controller, e.g., the controller 22, or other suitable processor or controller (not shown). The processor accesses the necessary instructions from the data storage device and executes the instructions or transfers the instructions to the appropriate location within the cordless telephone device 12.

Before the base station 16 will recognize the handset 18 and be able to communicate therewith, the handset 18 must be registered with the base station 16, e.g., using a pairing sequence, which creates a unique and encrypted or private wireless link between the base station 16 and the handset 18. Typically, an end user initiates the handset registration process or pairing sequence by pressing one or more buttons on the handset and/or the base station. The pairing sequence typically is performed in accordance with one or more conventional standards, such as the Digital Enhanced (previously European) Cordless Telecommunications (DECT) standard, its North American variant, Worldwide Digital Cordless Telecommunications (WDCT) standard, the Enhanced Digital Cordless Telecommunications (EDCT) standard, and the Bluetooth™ wireless standard.

As discussed, the cordless telephone base station 16 includes a mobile device interface 34 suitable for coupling the mobile device 14 to the cordless telephone base station 16. For example, as part of the cordless telephone base station 16, the mobile device interface 34 allows the mobile device 14 to be connected directly to the base station 16 and its internal components, such as the controller 22. Alternatively, the mobile device interface 34 can be part of an external handset node, dock or other component that can couple the mobile device 14 to the base station 16 via a wired connection or wirelessly via Bluetooth or other suitable wireless communication protocol.

The mobile device 14 can be any suitable device or devices suitable for use in a wireless telephony system, e.g., any telephony device that communicates wirelessly with a mobile or wireless network 36. Such wireless telephony devices include a mobile or cellular telephone, a smartphone, a personal digital assistant (PDA) or other wireless handheld device, a digital camera with wireless telephony capability, a mobile communication device, a laptop personal computer (PC) and a notebook PC.

In operation, the cordless telephone device 12 is available for the mobile device 14 to be connected to the cordless telephone base station 16, e.g., as discussed hereinabove. The mobile device 14, when operating and communicating with or through the mobile network 36, typically receives wireless data from the mobile network 36. The received wireless data can be in the form of voice data, message data and/or any other data suitable for transmission within a wireless network or wireless telephony system.

Voice data typically includes telephony signals representing the voice or speech of the calling and/or called parties. Typically, voice signals are analog audio signals that are converted to digital signals before transmission to the mobile devices, although such is not necessary. Another audio signal that is transmitted in the same audio band as conventional voice data is caller identification (or caller ID) information. Caller identification, or caller ID, is a telephony service or feature that transmits a caller's name and/or telephone number to the called party's telephony device as the call is being made but before the called party answers the call. The caller ID feature usually allows the called party to identify the calling party without having to answer the call. Caller ID information often is transmitted in the same manner and in the same audio band as voice data.

Message data includes text message data, such as one or more Short Message Service (SMS) text messages. As described hereinabove, Short Message Service (SMS) is a wireless service that allows the transmission of text messages between mobile devices. Message data, including data representing one or more text messages, typically is transmitted in a digital data path separate from voice data and the voice data audio band. Typically, SMS messages or SMS text messages can comprise words and/or numbers up to 160 characters in length. By comparison, caller ID information typically is no more than 32 characters in length and, as discussed hereinabove, often is part of the voice data transmitted to the mobile device 14, e.g., as a serial stream of voice data.

Text messages typically include the body of the text message, as well as one or more headers, which typically identify the sender, the receiver and the subject matter of the text message. Text messages longer than 160 characters typically are broken up into multiple text messages. Also, text messages typically require some amount of operating software and/or hardware and/or firmware in the receiving device to manage and/or organize received text messages. For example, managing text messages may involve the use and organization of one or more inboxes and the ability to scroll, display, remove and otherwise access the contents of the inboxes. Such is not necessary for voice data.

Conventionally, text messages are sent from one mobile device to another mobile device via a digital data path. An SMS message from a sending mobile device typically is sent to a Short Message Service Center (SMSC), which is located within the service provider's mobile network. The SMSC holds the message for the intended recipient mobile device and sends the message to the recipient's mobile device when the recipient mobile device is available. The transmission of SMS text messages, e.g., between the SMSC and mobile devices, can be performed according to one of many different communication protocols, including Signaling System #7 (SS7), which is a set of telephony signaling protocols, and Transmission Control Protocol/Internet Protocol (TCP/IP), which is a set of communications protocols used by the Internet and many commercial networks.

Returning to the operation of the cordless telephone device 12, when the mobile device 14 is connected to or otherwise associated with the cordless telephone base station 16, e.g., via a Bluetooth or other wireless networking association or suitable wireline connection, wireless data received by the mobile device 14 can be forwarded from the mobile device 14 to the base station 16 via the mobile device interface 34. The wireless data forwarded to the cordless telephone base station 16 is directed to the controller 22 for appropriate processing.

As discussed hereinabove, conventional cell phone docking or bridging devices can forward voice data received from a connected mobile device to a connected cordless base station. The voice signals then can be transmitted to the cordless telephone device's cordless handset via the respective transceivers. Because conventional bridging devices forward only voice signals to the cordless base station and handset, such conventional devices may or may not include a voice decoder, such as the voice processor 26 in the cordless telephone base station 16. However, since conventional bridging devices do not bridge text messages or other message data, such conventional bridging devices do not have a message decoder, such as the message processor 28 in the cordless telephone base station 16.

In the cordless telephone device 12 shown in FIG. 1, because both voice data and message data can be transported or bridged from the mobile device 14 to the cordless telephone base station 16, and because voice data and message data are different types of data that require different forms of processing, the cordless telephone device 12 must be able to distinguish between voice data and message data from among the data received from the mobile device 14.

As part of the processing of the wireless data received by the base station 16 and directed to the controller 22, the voice processor 26 is used to determine which portion or portions of the received wireless data is voice data. The voice processor 26 is configured to decode the received wireless data and determine which data is voice data. The voice processor 26 also is configured appropriately to notify or instruct the controller 22 which data is voice data. Alternatively, the voice processor 26 can encode or otherwise provide some sort of indicia along with or as part of the identified voice data for the controller 22 to be able to determine which data is voice data.

Also, as part of the processing of the wireless data received by the base station 16, the message processor 28 determines which portion or portions of the received wireless data directed to controller 22 is message data. The message processor 28 is configured appropriately to decode the received wireless data and determine which of the received wireless data is message data. As discussed hereinabove, message data typically includes header information identifying various aspects of the message data. Therefore, for example, the message processor 28 can look for message data header information as one way to identify message data.

The message processor 28 also is configured to make the controller 22 aware of which data is message data. For example, the message processor 28 can remove the message data from the received wireless data and provide the message data to the controller 22 separately from the non-message data. Alternatively, the message processor 28 can encode or otherwise associate some sort of indicia along with or as part of the identified message data that can be read by the controller 22 to identify the message data. Also, it should be understood that the message processor 28 can be configured to distinguish between different kinds of message data from among the identified message data. It should be understood that the voice processor 26 and the message processor 28 can be a single processor.

Once message data has been identified from among the wireless data that was received by the mobile device 14 and forwarded to the base station 16, the controller 22 can organize and manage the message data as needed for transmission to and display by the cordless handset 18. For example, the message data can be organized as a plurality entries in an inbox dedicated to one or more end users of the cordless telephone device 12.

Cordless telephone device handsets typically have a display screen that, conventionally, is used to display caller ID information and other information that may be associated with voice data. In the cordless telephone device 12, the cordless handset 18 has a display screen that is dimensioned and configured to display various message data. For example, the display screen can display at least a portion of the text message entries within a given inbox. Alternatively, the display screen can display a message indicating that a text message has been received and, e.g., followed by one or more portions of the received message, such as the sender or the subject matter line of the text message.

Also, the cordless handset 18 can be configured to include other visual and/or audible indicators that will let an end user know a text message has been bridged or transported from their associated mobile device 14. For example, the cordless handset 18 can include one or more ring tones or other sounds that can indicate the receipt of a text message. Alternatively, the cordless handset 18 can include one or more lights or other visual indicators to alert an end user to the receipt of a text message bridged from their associated mobile device 14.

The cordless telephone device 12, via its handset 18, also can be configured to transmit text messages to the mobile device 14, e.g., in response to the receipt of text messages transported from the mobile device 14. For example, the cordless handset 18 can be configured to transmit text messages or other information back to the cordless telephone base station 16, e.g., via the wireless link between the cordless handset 18 and the base station 16. The base station 16, in turn, can forward the text message information to the mobile device 14 docked or otherwise associated with the cordless telephone base station 16. In this manner, the cordless telephone device 12 can be used in much the same manner as the mobile device 14 bridged thereto.

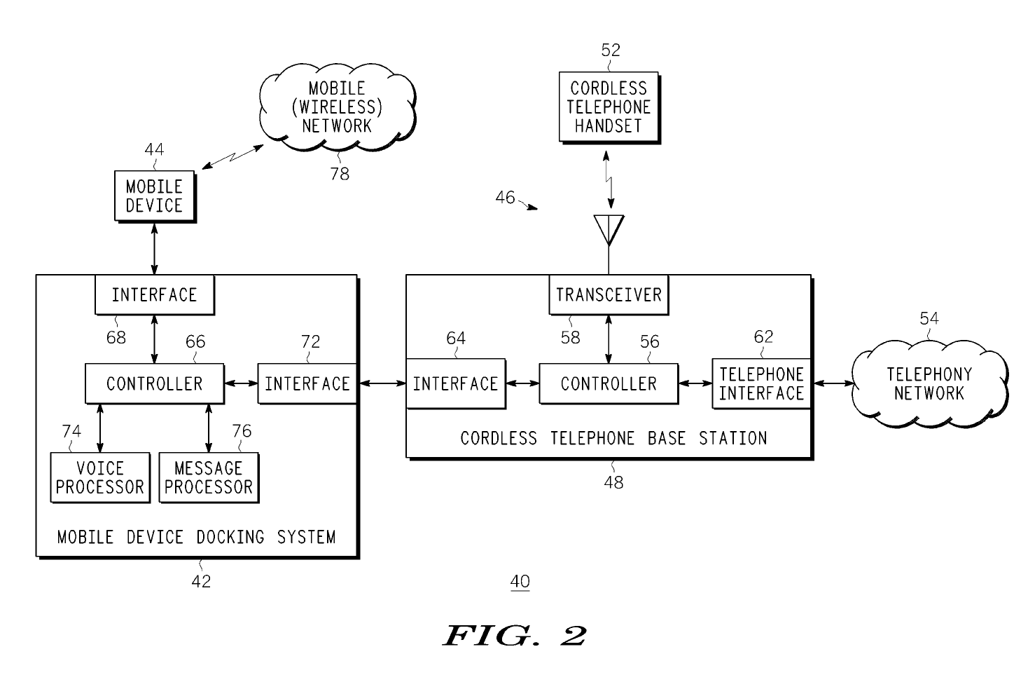

Referring now to FIG. 2, shown is a block diagram of another system 40 for transporting wireless text message data between a mobile device and a cordless telephone device. Unlike the system 10 in FIG. 1, in which the cordless telephony device 12 has incorporated therein the ability to transport wireless text message data from an associated mobile device 14, the system 40 in FIG. 2 includes a mobile device docking system, external to the cordless telephony device, for transporting wireless text message data between a mobile device and a cordless telephone device.

The system 40 includes a mobile device docking station 42 for transporting or bridging text message data between a mobile device 44 and a cordless telephony or telephone device 46. The cordless telephone device 46 typically includes a cordless telephone base station 48 and one or more portable, cordless telephone handsets 52. The cordless base station 48 is connected to a telephony network 54, such as a telephone company phone system, via a landline telephone connection or other suitable connection.

The cordless telephone base station 48 includes a controller 56 and a cordless transceiver or radio transceiver 58 coupled to the controller 56. The transceiver 58 communicates wirelessly with the cordless handset 52, which also includes a cordless or radio transceiver (not shown). The controller 56 generally controls the operation of the cordless telephone device 46, including the administration of wireless communications between the base station 48 and the handset 52, and between the base station 48 and the telephony network 54. The cordless telephone base station 48 also includes a telephone interface 62 for coupling the cordless telephone device 46 to the telephony network 54, and a mobile device or mobile device docking interface 64 for coupling the cordless telephone device 46 to a mobile device 14 via the mobile device docking station 42.

The mobile device docking station 42 includes a docking controller 66, a mobile device interface 68 coupled to the docking controller 66, and a cordless telephone device interface 72 coupled to the docking controller 66. The mobile device docking station 42 also includes a voice processor 74 voice processor 74 and a message processor 76 message processor 76, both of which are coupled to the docking controller 66.

The mobile device docking station 42 can be partially configured in the form of hardware circuitry and/or other hardware components within a larger device or group of components. Alternatively, the mobile device docking station 42 can be partially or completely configured in the form of software, e.g., as processing instructions and/or one or more sets of logic or computer code. In such configuration, the logic or processing instructions typically are stored in a data storage device (not shown). The data storage device typically is coupled to a processor or controller, e.g., the docking controller 66, or other suitable processor or controller (not shown). The processor accesses the necessary instructions from the data storage device and executes the instructions or transfers the instructions to the appropriate location within the mobile device docking station 42.

One or more of the docking controller 66, the mobile device interface 68, the cordless telephone device interface 72, the voice processor 74 and the message processor 76 can be comprised partially or completely of any suitable structure or arrangement, e.g., one or more integrated circuits. Also, it should be understood that the mobile device docking station 42 includes other components, hardware and software (not shown) that are used for the operation of other features and functions of the mobile device docking station 42 not specifically described herein.

The mobile device docking station 42 can be any suitable device that supports the coupling of a mobile device, such as the mobile device 44, to a cordless telephone device, such as the cordless telephone device 46. Also, it should be understood that the mobile device docking station 42 can be part of or connected to a residential gateway, a home media server, a home area network (HAN) server, a signal converter box, a signal decoder box, a digital set-top box, a digital video disk recorder, a personal video recorder (PVR) device, a networking device, such as an 802.11x networking device, a wireless router, a desktop personal computer (PC), a laptop PC, a notebook PC, a television, an audio receiver and a video receiver.

The cordless device interface 72 couples the mobile device docking station 42 to the cordless telephone base station 48, as will be discussed in greater detail hereinbelow. It should be understood that the interfaces 68, 72 can be a single interface or part of a single interface configured to couple the mobile device docking station 42 to one or both of the cordless telephone base station 48 and the mobile device 44.

The mobile device interface 68 couples the mobile device 14 to the mobile device docking station 42, e.g., directly via a wired connection or wirelessly via Bluetooth or other suitable wireless communication protocol. As with the mobile device 14 discussed hereinabove, the mobile device 44 can be any device suitable for use in a wireless telephony system, e.g., any telephony device that communicates wirelessly with a mobile or wireless network 78. Such wireless telephony devices include a mobile or cellular telephone, a smartphone, a personal digital assistant (PDA) or other wireless handheld device, a digital camera with wireless telephony capability, a mobile communication device, a laptop personal computer (PC) and a notebook PC.

In general, in operation, the mobile device docking station 42 is a device that allows the mobile device 44 to be coupled to an existing or conventional cordless telephone base station 48 in a manner that allows wireless message data to be transported or bridged from the mobile device 44 to the cordless telephone base station 48. Unlike the cordless telephone base station 16 in FIG. 1, which includes a voice decoder (voice processor 26) and a message decoder (message processor 28) internally, the mobile device docking station 42 typically is for use with cordless telephone base stations that do not have such decoder, e.g., existing conventional cordless telephone base stations 48. In this manner, the mobile device docking station 42 can be used to upgrade the functionality of an existing conventional cordless telephone base station 48 in the manner described herein, i.e., to bridge wireless message data between a mobile device and the conventional cordless telephone base station.

When the mobile device 44 is connected to or otherwise associated with the mobile device docking station 42, e.g., via a Bluetooth or other wireless networking association, wireless data received by the mobile device 44, e.g., from the wireless network 78, can be forwarded from the mobile device 44 to the mobile device docking station 42, e.g., via the mobile device interface 68. As discussed hereinabove, the received wireless data can be in the form of voice data, message data and/or any other data suitable for transmission within a wireless network or wireless telephony system. The wireless data forwarded to the mobile device docking station 42 typically is directed to the docking controller 66 for appropriate processing.

As discussed hereinabove, conventional cell phone docking or bridging devices can forward voice data received from a connected mobile device to a connected cordless base station. The voice signals then can be transmitted to the cordless device's cordless handset via its transceiver. Because conventional bridging devices forward only voice signals to the cordless base station and handset, such conventional devices may or may not include a voice decoder, such as the voice processor 74. However, since conventional bridging devices do not bridge text messages or other message data, such conventional bridging devices do not have a message decoder, such as the message processor 76.

As with the cordless telephone base station 16 in the system 10 in FIG. 1, the mobile device docking station 42 is able to transport or bridge both voice data and message data from the mobile device 44 to the cordless telephone base station 48. As discussed hereinabove, because voice data and message data are different types of data that require different forms of processing, the mobile device docking station 42 must be able to distinguish between voice data and message data from among the data received from the mobile device 14. Unlike conventional docking or bridging devices, the mobile device docking station 42 is configured to distinguish between voice data and message data from among the data received from the mobile device 44.

Within the mobile device docking station 42, the voice processor 74 is configured to decode the received wireless data and determine which data is voice data. The voice processor 74 also is configured appropriately to instruct the controller 22 which data is voice data and/or encode or otherwise provide some sort of indicia along with or as part of the identified voice data for the controller 22 to be able to determine which data is voice data.

Also, within the mobile device docking station 42, the message processor 76 is configured to decode the received wireless data and determine which data is message data. The message processor 76 also instructs the controller 22 as to which data is message data, and/or encodes or otherwise provides some sort of indicia along with or as part of the identified message data for the controller 22 to be able to determine which data is message data. Also, it should be understood that the message processor 76 can be configured to distinguish between different kinds of message data from among the identified message data, and provide distinguishing indicia if necessary. It should be understood that the voice processor 74 and the message processor 76 can be a single processor.

Once message data has been identified from among the wireless data that was received by the mobile device 14 and forwarded to the mobile device docking station 42, the docking controller 66 can organize and manage the message data as needed for transmission to the cordless telephone base station 48. Part of this process includes converting and/or configuring the message data in such a way that the message data can be read suitably by the cordless telephone base station 48. For example, since conventional cordless telephone base stations can read caller ID information, the docking controller 66 can transmit message data to the cordless telephone base station 48 as a series of caller ID streams. It should be understood that the docking controller 66 can be configured in any other suitable manner to provide the message data to the cordless telephone base station 48 in a format that can be read by the cordless telephone base station 48.

Although the systems, devices and methods described herein have been discussed mostly with respect to SMS text messages, it should be understood that the systems, devices and methods described herein are suitable for use with other types of message data, including message data transmitted by various data services, such as Multimedia Messaging Service (MMS). MMS is a standard for telephony messaging systems that allow the transmission and receipt of messages that include multimedia objects, such as images, audio, video and text.

The protocols used to implement all or a portion of the system 10 and/or the system 40 may include one or more of the following: cordless telephony protocols, such as but not limited to Digital Enhanced Cordless Telephony (DECT), mobile telephony call signaling, e.g., the integrated dispatch enhanced network (iDEN) Network, time division multiple access (TDMA), time division multiple access (CDMA), CDMA-2000, and global system for mobile communications (GSM); IP-based Telephony Signaling, e.g., Packet Cable Network-based Call Signaling (NCS), Packet Cable Duos, session initiation protocol (SIP), simple gateway control protocol (SGCP), media gateway control protocol (MGCP) and any protocol in accordance with the H.323 standard; the Public Switched Telephone Network (PSTN); and local network interfaces that support voice and data traffic, such as but not limited to Bluetooth™, and any protocols in accordance with the following standards: IEEE 802.11b, IEEE 802.11a, IEEE 802.11g, IEEE 802.11h, IEEE 802.11e and HomeRF™. The system 10 and/or the system 40 also can apply to handsets that can connect to a wired local network in accordance with the Home Phoneline Networking Alliance (HPNA), the Home Plug Powerline Alliance, 10/100BaseT Ethernet, universal serial bus (USB) and IEEE 1394, broadband networking including hybrid-fiber coax network, which includes Data Over Cable Service Interface Specification (DOCSIS) compliant protocols and IP Telephony protocols, Digital Subscriber Line (DSL) Modems and Networks, Fixed Wireless Networks (e.g., multichannel multipoint distribution service (MMDS) and local multipoint distribution service (LMDS)), Bluetooth™ Protocol Specification, and PacketCable™ and Network-Based Call Signaling Protocol Specification (NCS). Those skilled in the art will recognize that all or a portion of the system 10 and/or the system 40 may be implemented using virtually any type of local area network protocol currently existing or to be developed in the future.

The message data transporting systems, devices and methods described herein may be implemented in a general, multi-purpose or single purpose processor. Such a processor will execute instructions, either at the assembly, compiled or machine-level, to perform that process. Those instructions can be written by one of ordinary skill in the art following the description of the data traffic routing method described herein and stored or transmitted on a computer readable medium. The instructions may also be created using source code or any other known computer-aided design tool. A computer readable medium may be any medium capable of carrying those instructions and includes random access memory (RAM), dynamic RAM (DRAM), flash memory, read-only memory (ROM), compact disk ROM (CD-ROM), digital video disks (DVDs), magnetic disks or tapes, optical disks or other disks, silicon memory (e.g., removable, non-removable, volatile or non-volatile), packetized or non-packetized wireline or wireless transmission signals.

It will be apparent to those skilled in the art that many changes and substitutions can be made to the text message transporting system, method and apparatus herein described without departing from the spirit and scope of the invention as defined by the appended claims and their full scope of equivalents.

1. A cordless telephone device, comprising:
a base station configured for coupling to a mobile device configured to transmit and receive wireless data including voice data and message data via a wireless network; and
at least one handset coupled to the base station,
wherein the base station includes
a controller configured to receive wireless data including voice data and message data from the mobile device,
a data processor coupled to the controller for determining message data from the data received by the base station, and
a transceiver coupled to the controller for transmitting and receiving between the base station and the at least one handset message data received by the controller,
wherein the controller is configured to transmit and receive message data between the mobile device and the handset when the mobile device is coupled to the base station.

2. The device as recited in claim 1, wherein the message data includes at least one Short Message Service (SMS) text message.

3. The device as recited in claim 1, wherein the handset includes at least one of an audible indication and a visual indication that is activated to indicate the receipt of message data by the cordless telephone device.

4. The device as recited in claim 1, wherein the cordless telephone device is Bluetooth-enabled, wherein the mobile device is Bluetooth-enabled, and wherein message data is transported between the mobile device and the cordless telephone device according to a Bluetooth communication protocol.

5. The device as recited in claim 1, wherein message data is transported between the base station and the handset according to a communication protocol selected from the group consisting of the Digital Enhanced Cordless Telecommunications (DECT) standard, the Worldwide Digital Cordless Telecommunications (WDCT) standard, and the Enhanced Digital Cordless Telecommunications (EDCT) standard.

6. The device as recited in claim 1, wherein the mobile device is a mobile device selected from the group consisting of a cellular telephone, a smartphone, a personal digital assistant (PDA), a wireless handheld device, a digital camera, a mobile communication device, a laptop personal computer (PC) and a notebook PC.

7. The device as recited in claim 1, wherein the cordless telephone device is at least a portion of a device selected from the group consisting of a signal converter box, a signal decoder box, a digital set-top box, a residential gateway, a home media server, a home area network (HAN) server, a digital video disk recorder, a personal video recorder device, an 802.11x networking device, a wireless router, a desktop personal computer (PC), a laptop PC, a notebook PC, a television, an audio receiver and a video receiver.

8. The device as recited in claim 1, wherein the controller is configured to receive message data from the mobile device via at least one of a wired connection and wirelessly.

9. The device as recited in claim 1, wherein at least a portion of the controller is implemented in hardware.

10. The device as recited in claim 1, wherein at least a portion of the controller is implemented in software executed by a computer.

11. A mobile device docking system, comprising:
a docking controller;
a mobile device interface coupled to the docking controller for coupling a mobile device to the docking controller, wherein the mobile device is configured to transmit and receive wireless data including voice data and message data via a wireless network;
a cordless telephone interface coupled to the docking controller for coupling a cordless telephone device to the docking controller, wherein the cordless telephone device is configured to receive and transmit data including voice data and message data; and
a data processor coupled to the docking controller for determining message data from the data received by the docking controller,
wherein the docking controller is configured to transport at least a portion of the message data identified by the data processor between the mobile device and the cordless telephone when the mobile device is coupled to the mobile device interface and the cordless telephone is coupled to the cordless telephone interface.

12. The device as recited in claim 11, wherein the message data includes at least one Short Message Service (SMS) text message.

13. The device as recited in claim 11, wherein the cordless telephone device includes a handset, and wherein the docking controller transports message data to the cordless telephone device in such a way that at least one of an audible indication and a visual indication on the handset is activated to indicate the receipt of message data by the cordless telephone device.

14. The device as recited in claim 11, wherein the mobile device is Bluetooth-enabled, wherein the mobile device docking system is Bluetooth-enabled, and wherein message data is transported between the mobile device and the mobile device docking system according to a Bluetooth communication protocol.

15. The device as recited in claim 11, wherein the cordless telephone device is Bluetooth-enabled, wherein the mobile device docking system is Bluetooth-enabled, and wherein message data is transported between the cordless telephone device and the mobile device docking system according to a Bluetooth communication protocol.

16. The device as recited in claim 11, wherein the mobile device is a mobile device selected from the group consisting of a cellular telephone, a smartphone, a personal digital assistant (PDA), a wireless handheld device, a digital camera, a mobile communication device, a laptop personal computer (PC) and a notebook PC.

17. The device as recited in claim 11, wherein the mobile device docking system is at least a portion of a device selected from the group consisting of a signal converter box, a signal decoder box, a digital set-top box, a residential gateway, a home media server, a home area network (HAN) server, a digital video disk recorder, a personal video recorder device, a wireless router, an 802.11x networking device, a desktop personal computer (PC), a laptop PC, a notebook PC, a television, a mobile communication device, an audio receiver and a video receiver.

18. The device as recited in claim 11, wherein the docking controller is configured to receive message data from the mobile device via at least one of a wired connection and wirelessly.

19. The device as recited in claim 11, wherein at least a portion of the mobile device docking system is implemented in hardware.

20. The device as recited in claim 11, wherein at least a portion of the mobile device docking system is implemented in software executed by a computer.
